(19) United States
(12) Patent Application Publication
(10) Pub. No.: US 2018/0196591 A1
(43) Pub. Date: Jul. 12, 2018

(54) MOVING INTERFACE CONTROLS

(71) Applicant: Microsoft Technology Licensing, LLC, Redmond, WA (US)

(72) Inventors: Carolina Hernandez, Seattle, WA (US); Akshatha Kommalapati, Bellevue, WA (US); Lucas Matthew Scotta, Seattle, WA (US); Max Michael Benat, Redmond, WA (US)

(73) Assignee: Microsoft Technology Licensing, LLC, Redmond, WA (US)

(21) Appl. No.: 15/403,020

(22) Filed: Jan. 10, 2017

(51) Int. Cl. G06F 3/0484; G06F 3/0486

(52) U.S. Cl. CPC G06F 3/04847; G06F 2203/04803; G06F 3/04845; G06F 3/0486

(57) ABSTRACT

A method for moving an interface control includes displaying, via a graphical user interface of a computing display, an interface control having a first appearance at a first interface surface of the graphical user interface. Via a computing device operatively coupled to the computing display, a user input to move the interface control to a second interface surface is received. Upon receiving the user input, the interface control is displayed with a second appearance at the second interface surface. Based on displaying the interface control at the second interface surface of the graphical user interface, display of the interface control at the first interface surface is discontinued. The interface control provides a first level of functionality when displayed at the first interface surface and a second level of functionality when displayed at the second interface surface.

### BACKGROUND

Computer operating systems, programs, applications, and other forms of software often facilitate user interaction via a graphical user interface presented via a computing display. Graphical user interfaces often include one or more interface controls that the user can interact with to alter settings or behaviors of an underlying computing device, including, for example, changing settings of a software application, or changing operation of one or more hardware components of the computing device.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

A method for moving an interface control includes displaying, via a graphical user interface of a computing display, an interface control having a first appearance at a first interface surface of the graphical user interface. Via a computing device operatively coupled to the computing display, a user input to move the interface control to a second interface surface is received. Upon receiving the user input, the interface control is displayed with a second appearance at the second interface surface. Based on displaying the interface control at the second interface surface of the graphical user interface, display of the interface control at the first interface surface is discontinued. The interface control provides a first level of functionality when displayed at the first interface surface and a second level of functionality when displayed at the second interface surface.

### BRIEF DESCRIPTION OF THE DRAWINGS

FIG. 1 illustrates an example method for moving an interface control.

FIG. 2 schematically shows an example graphical user interface including a first interface surface and a second interface surface.

FIGS. 3A and 3B schematically illustrate selective display of a first interface surface and persistent display of a second interface surface.

FIGS. 4A and 4B schematically illustrate movement of an interface control from a first interface surface to a second interface surface.

FIGS. 4C and 4D schematically illustrate movement of an interface control from a second interface surface to a first interface surface.

FIGS. 5A and 5B schematically illustrate display of first and second interface windows based on user-selection of the interface control at the first interface surface and the second interface surface.

FIG. 6 schematically shows an example computing device.

### DETAILED DESCRIPTION

Graphical user interfaces associated with software applications and computer operating systems often include interface controls that can be manipulated to change behaviors of an underlying computing device. For example, such interface controls can be used to adjust audio volume, change screen brightness, change power settings, manage wireless connectivity, unmount attached storage devices, etc. Such interface controls are often grouped together in one or more interface surfaces of a graphical user interface, which can take the form of menus, toolbars, application trays, tabs, etc. Accordingly, it can be difficult for users to learn and remember where various interface controls are located within a graphical user interface, especially when the graphical user interface does not provide a way for the user to move or customize where interface controls are located. Even when user-customization of a graphical user interface is possible, such customization is often limited to simply moving an icon from one location to another, and does not allow the user to change how the graphical user interface looks or behaves in meaningful ways.

Accordingly, the present disclosure is directed to a technique for moving interface controls from one interface surface to another. According to this approach, a user can provide a user input to move an interface control from a first interface surface to a second interface surface, and this can change both an appearance of the interface control and a level of functionality associated with the interface control. In this manner, the user can, for example, move frequently-accessed interface controls to convenient and persistently-displayed interface surfaces, where the interface controls will be displayed with an appearance and provide a level of functionality appropriate to the interface control at which they are displayed. Allowing a user to customize a graphical user interface in this manner can improve the functionality of the underlying computing device by allowing the user to more efficiently perform desired functions and review important information.

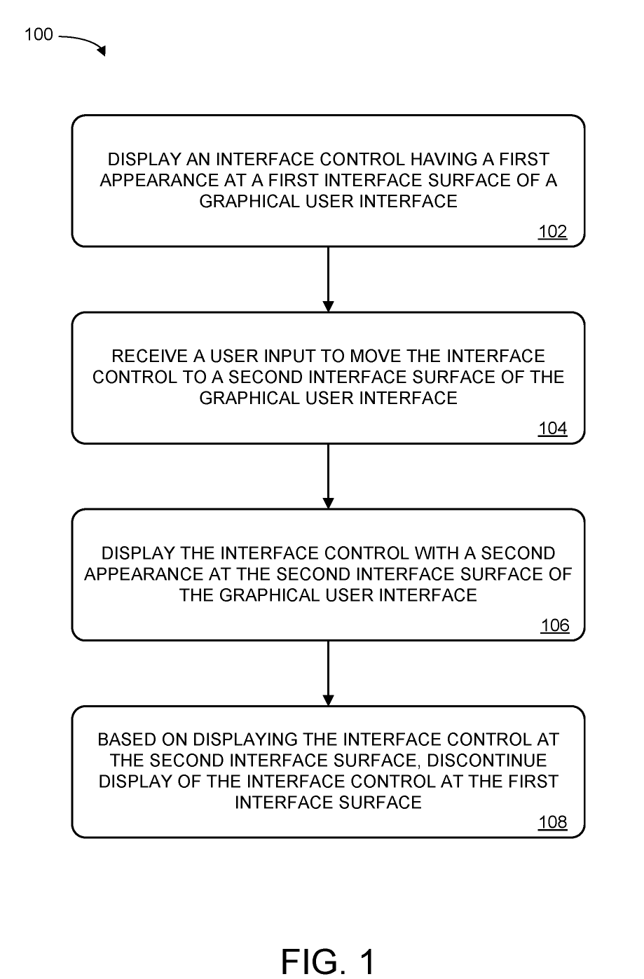

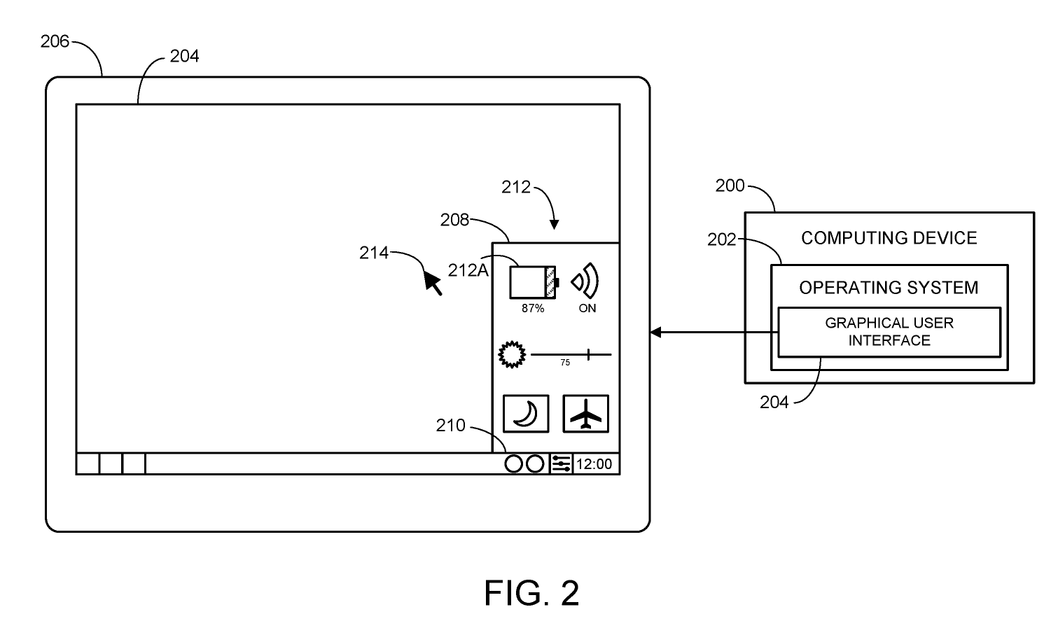

FIG. 1 illustrates an example method 100 for moving an interface control. At 102, method 100 includes displaying an interface control having a first appearance at a first interface surface of a graphical user interface. This is schematically shown in FIG. 2, which shows an example computing device 200 having an operating system 202 and rendering a graphical user interface 204.

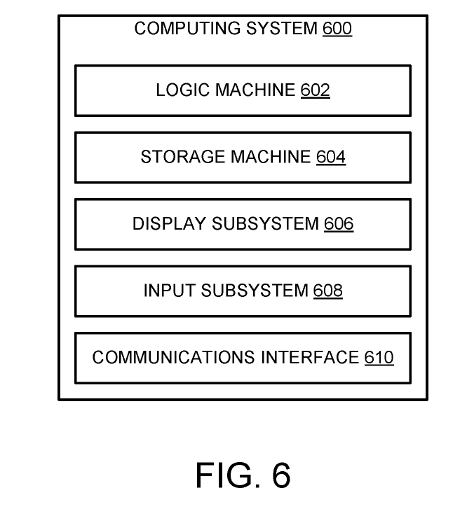

Computing device 200 may take a variety of suitable forms. For example, computing device 200 may be implemented as a desktop computer, laptop computer, tablet computer, smartphone, wearable computing device, home media center, video game console, smartTV, and/or any other computing device usable for rendering a graphical user interface. Computing device 200 may be implemented as the computing system 600 described below with respect to FIG. 6. Similarly, operating system 202 may take a variety of forms, and generally can be implemented as any software installable on computing device 200 that manages system hardware and software resources and facilitates user interaction with the computing device. In some implementations, graphical user interface 204 may be a user interface or shell provided by an operating system. In other implementations, graphical user interface 204 may be provided and rendered by a software application installed on computing device 200. Regardless of how the graphical user interface is rendered, it will generally provide a user of the computing device with control over one or more software functions and/or hardware components of the computing device, often via one or more interface controls, as will be described below.

In FIG. 2, graphical user interface 204 is shown displayed on a computing display 206. As will be described below with respect to FIG. 6, computing display 206 may utilize any suitable display technology. In some cases, computing device 200 and computing display 206 may share a common housing. In other cases, computing device 200 and computing display 206 may be separate devices, and interact via any suitable wired or wireless interface. In general, computing display 206 is operatively coupled to computing device 200 such that graphical content rendered by the computing device is displayed via the computing display.

As shown in FIG. 2, graphical user interface 204 includes a first interface surface 208, taking the form of a vertical sidebar surface, and a second interface surface 210, taking the form of a horizontal tray surface. Though only two interface surfaces are shown in graphical user interface 204, a graphical user interface as described herein can have any number of interface surfaces, each having any suitable appearance and position. Each of the first interface surface and the second interface surface include a plurality of interface controls 212 distributed between the two interface surfaces. Interaction with an interface control may cause a change in operation of one or more software applications and/or hardware components of the computing device operatively connected to the computing display.

FIG. 2 specifically shows an interface control 212A, taking the form of a power management control. A user of the computing device may interact with interface control 212A to view and/or change power management settings of the computing device, for example. Other interface controls 212 shown in FIG. 2 may allow a user to, for example, manage wireless connectivity of the computing device, change a brightness of computing display 204, place the device into an “airplane” mode or a “quiet” mode, change time-and-date settings, etc. The specific interface controls described above and illustrated in the figures are not intended to be limiting, and graphical user interfaces as described herein may include any suitable interface controls having virtually any appearance, position, and functionality. Further, the specific appearance of graphical user interface 204 is not intended to be limiting, and the present disclosure applies to graphical user interfaces having any suitable appearances and arrangements.

A user may interact with interface controls and interface surfaces of a graphical user interface in a variety of ways. For example, the user may use a computer mouse, or other suitable input device, to control a cursor, such as cursor 214 shown in FIG. 2. In other implementations, a user may provide user input by touching a touch screen, providing vocal commands, etc.

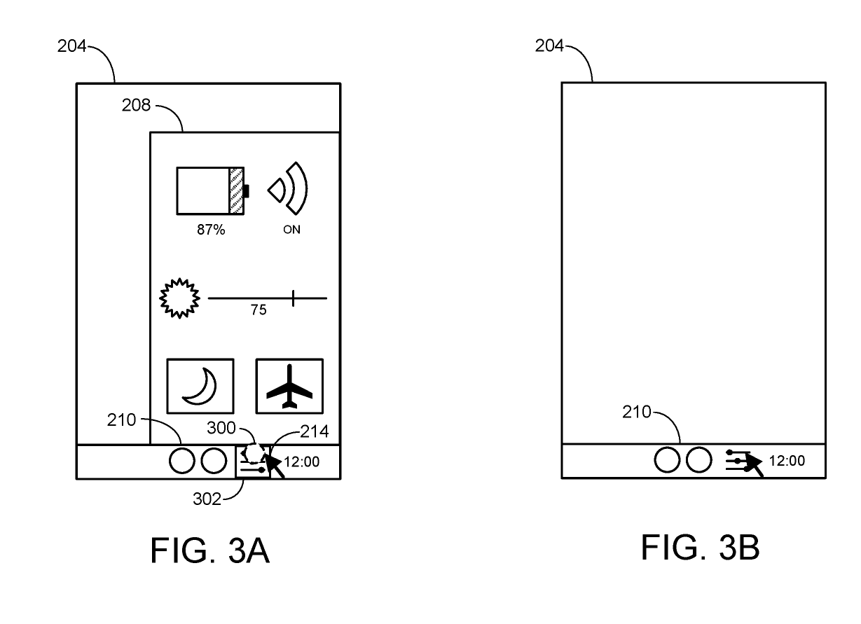

In some implementations, one or more interface surfaces of a graphical user interface may be selectively displayed responsive to receiving a user input, while other user interfaces may be persistently displayed. This is schematically illustrated in FIGS. 3A and 3B, which show a portion of graphical user interface 204 as displayed by computing display 206. In FIG. 3A, both first interface surface 208 and second interface surface 210 are displayed. The user of the computing device has provided a user input 300 (schematically illustrated as a dashed circle) at an interface display toggle 302 via cursor 214. Upon the computing device receiving user input 300, display of the first interface surface in the graphical user interface 204 is discontinued.

This is illustrated in FIG. 3B, which shows the same portion of graphical user interface 204. In contrast to FIG. 3A, first interface surface 208 is not displayed in FIG. 3B. In other words, first interface surface 208 is selectively displayed, and display of the first interface surface may be toggled by the user by providing user input at the location of interface display toggle 302. Meanwhile, second interface surface 210 is persistently displayed. Interface display toggle 302 is provided herein for the sake of example, and is not intended to limit the present disclosure. In general, a graphical user interface may include one or more interface surfaces that are selectively displayed, and the conditions under which such interface surfaces are displayed/hidden can vary from implementation to implementation.

Though second interface surface 210 is described above as being “persistently displayed.” there may be some circumstances in which the second interface surface is not displayed in the graphical user interface. For example, a user may choose to view a picture, video, or other media in “full-screen” mode, in which the second interface surface may be hidden by the displayed media. Accordingly, the term “persistently displayed” may, in some implementations, refer to any interface surfaces or controls that are displayed by default, and only hidden responsive to specific user input. Similarly, the term “selectively displayed” may refer to any interface surfaces or controls (such as first interface surface 208) that are not shown by default, and only displayed responsive to receiving specific user input (e.g., providing user input at interface display toggle 302).

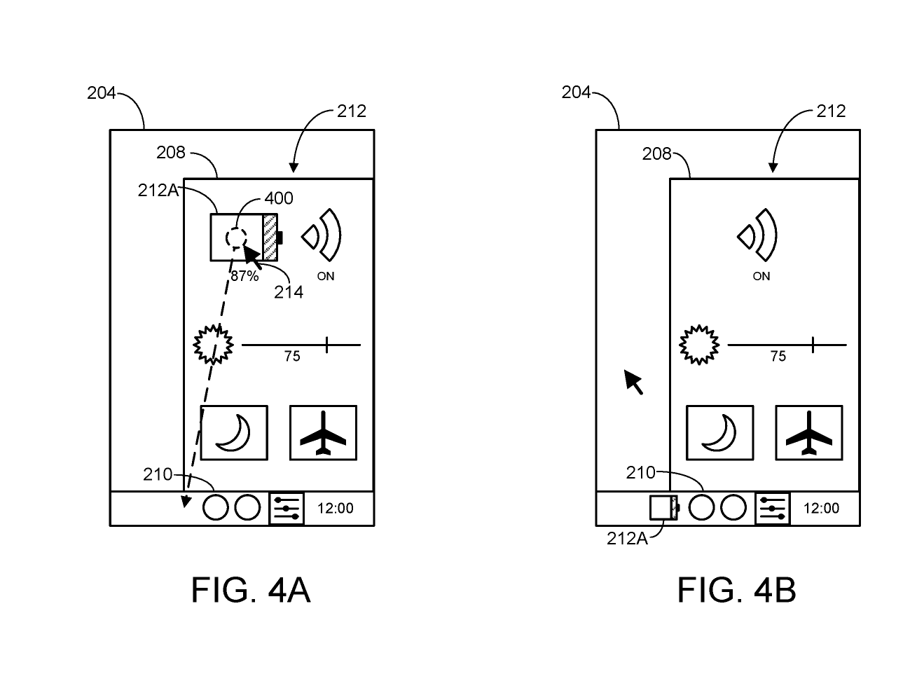

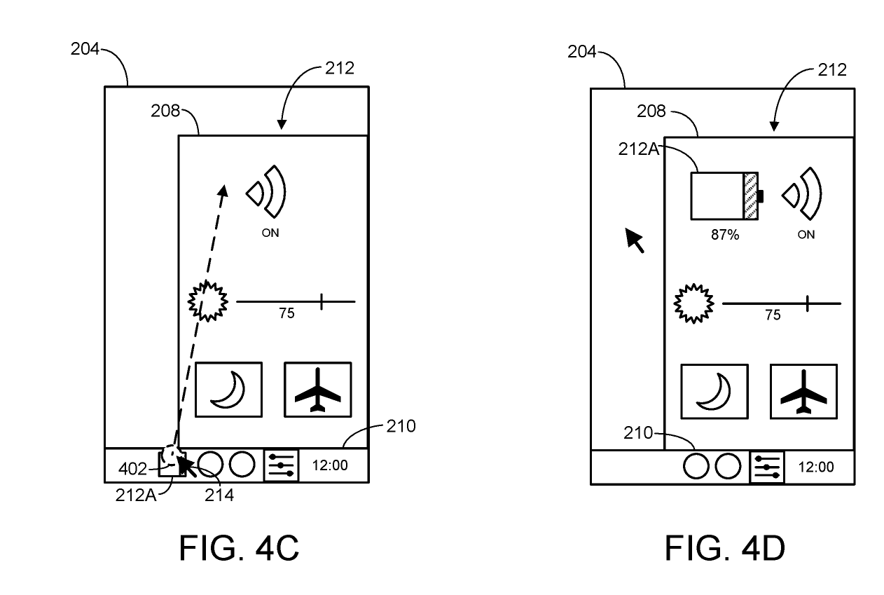

Returning briefly to FIG. 1, at 104, method 100 includes receiving a user input to move the interface control to a second interface surface of the graphical user interface. This is schematically shown in FIG. 4A, which again shows a portion of user interface 204 including first interface surface 208 and second interface surface 210. In FIG. 4A, a user has provided a user input 400 via cursor 214 to move interface control 212A from the first interface surface to the second interface surface. As indicated above, this user input may take a variety of suitable forms, and need not necessarily involve movement or manipulation of a cursor. For example, user input 400 may comprise a “drag-and-drop” operation, performed, for example, via movement of a computer mouse, or by interacting with a touch sensor.

Returning to FIG. 1, at 106, method 100 includes displaying the interface control at the second interface surface via the graphical user interface of the computing display. This is schematically shown in FIG. 4B, in which interface control 212A is shown at the second interface surface, in response to user input 400 shown in FIG. 4A. When displayed at the second interface surface, interface control 212A has a different size and appearance from when it was displayed at the first interface surface. Specifically, the interface control has a larger size and visually presents more information when displayed at the first interface surface of the graphical user interface than when displayed at the second interface surface of the graphical user interface. In other words, one or both of an appearance and a size of the interface control may change when it is moved from one interface surface to another. Accordingly, interface control 212A has a first appearance and a first size when displayed at the first interface surface and a second appearance and a second size when displayed at the second interface surface.

Further, the appearance and/or size of an interface control may change in any suitable manner when it is moved from one interface surface to another, and the nature of this change may depend on the size, position, and/or nature of the interface surface at which the interface control is displayed. For example, in the illustrated embodiment, the second interface surface is smaller than the first interface control. Therefore, when displayed at the second interface surface, interface control 212A is smaller and visually presents less information as compared to when displayed at the first interface surface, as the second interface surface has less room. In other examples, interface controls may change in other suitable ways, depending on the interface surface at which they are moved to/displayed at.

Though FIGS. 4A and 4B only show a single interface control (i.e., interface control 212A) being moved from the first interface surface to the second surface, it will be understood that any interface controls displayed at either the first or the second interface surface may be moved to a different interface surface based on user input. For example, each of the interface controls 212 shown in FIGS. 4A and 4B may be moved between the two interface surfaces at will, and each of the interface controls may assume a size and appearance that is appropriate for the interface surface at which they are displayed. In general, each of a first interface surface and a second interface surface of a graphical user interface may include a plurality of interface controls, and each of the plurality of interface controls may be moveable between the first and second interface surfaces based on user input.

Returning briefly to FIG. 1, at 108, method 100 includes, based on displaying the interface control at the second interface surface, discontinuing display of the interface control at the first interface surface. This is also schematically shown in FIG. 4B, as interface control 212A is no longer shown at first interface surface 208 once it is shown at second interface surface 210. However, in some implementations, display of the interface control at the first interface surface need not be discontinued once the interface control has been moved to the second interface surface.

Though the above focuses on moving an interface control from a first interface surface to a second interface surface, the opposite is also supported, in which an interface control is moved from the second interface surface to the first interface surface. This is schematically illustrated in FIGS. 4C and 4D. FIG. 4C shows the same portion of user interface 204, in which first interface surface 208 and second interface surface 210 are visible. In FIG. 4C, interface control 212A is located at the second interface surface. A user has provided a user input 402 via cursor 214 to move interface control 212A from the second interface surface to the first interface surface. Accordingly, in FIG. 4D, interface control 212A is shown at the first interface surface, and display of interface control 212A at the second interface surface has been discontinued. Once again, a size and appearance of the interface control has changed based on the interface control to which it was moved.

In some implementations, an interface control can provide a different level of functionality depending on the interface surface at which it is presented. In other words, an interface control can provide a first level of functionality when it is presented at the first interface surface, and a second, different level of functionality when it is presented at the second interface surface. For example, an interface control of a graphical user interface may allow a user to adjust a screen brightness of a computing display. When displayed at the first interface surface, this interface control may take the form of a slider, and allow the user to continuously adjust the screen brightness from a minimum value to a maximum value. However, if the user moves the interface control to the second interface surface, then the appearance and functionality of the interface control may change. For example, when presented at the second interface surface, the interface control may take the form of a simple button that increases/decreases screen brightness by a fixed amount each time it is pressed, for example. In this manner, the second interface surface may provide a quick and easy way to adjust basic settings, while the first interface surface is less immediately accessible though allows for more specific control of the computing device. In general, an interface control can provide any suitable functionality, and the specific functionality provided can depend on the interface surface at which the interface control is presented.

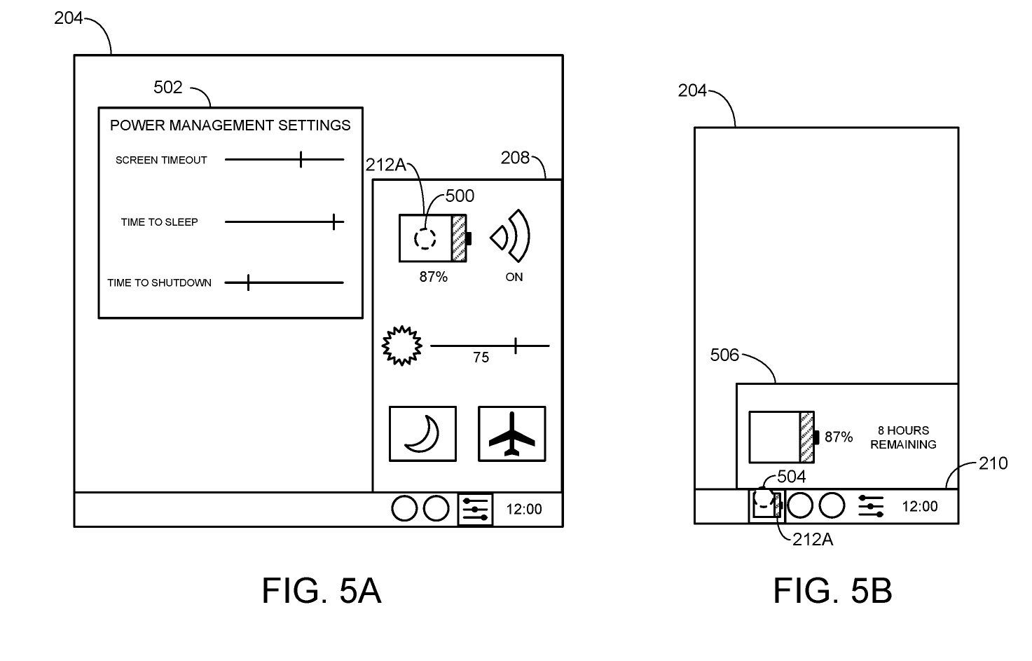

A single interface control having different functionality depending on the interface surface at which it is presented is schematically illustrated in FIGS. 5A and 5B. FIG. 5A again shows a portion of graphical user interface 204, in which interface control 212A is displayed at first interface surface 208. In FIG. 5A, a user is providing a user input 500 at the position of interface control 212A. User-selection of the interface control while it is presented at the first interface surface has caused presentation of a first interface window 502 on the computing display.

Because interface control 212A is a power management control, first interface window 502 allows for adjustment of power management settings. Specifically, first interface window 502 allows the user to change the length of time that must pass before the computing display times out (e.g., dims or turns off), the length of time that must pass before the computing system automatically enters “sleep” mode, and the length of time that must pass before the computing device automatically shuts down. It will be appreciated that first interface window 502 is presented as an example, and users may adjust any suitable settings via interface windows. Further, first interface window 502 is separate from the first interface surface of the graphical user interface. In some implementations, an interface window presented in response to user-selection of an interface control may be provided or rendered by a different software application or operating system component than the software application/operating system component providing the graphical user interface. Further, user-interaction with interface controls may cause presentation of any number and variety of interface windows.

In FIG. 5B, interface control 212A has been moved to second interface surface 210, and first interface surface 208 is no longer displayed in graphical user interface 204. The user is providing a user input 504 at the location of interface control 212A in second interface surface 210. User-selection of the interface control while it is displayed at the second interface surface causes display of a second, different interface window 506 on the computing display. As shown, second interface window 506 is contiguous with the second interface surface of the graphical user interface, in contrast to first interface window 502, which is separate from first interface surface 208. Second interface window 506 includes different information from first interface window 502, and may allow the user to change different settings in different ways. This further illustrates how the level of functionality provided by an interface control can vary depending on the interface surface at which it is presented.

In some embodiments, the methods and processes described herein may be tied to a computing system of one or more computing devices. In particular, such methods and processes may be implemented as a computer-application program or service, an application-programming interface (API), a library, and/or other computer-program product.

FIG. 6 schematically shows a non-limiting embodiment of a computing system 600 that can enact one or more of the methods and processes described above. In particular, computing system 600 may render and display a graphical user interface via a computing display, and enable interface controls of the graphical user interface to be moved between various interface surfaces. Computing system 600 is shown in simplified form. Computing system 600 may take the form of one or more personal computers, server computers, tablet computers, home-entertainment computers, network computing devices, gaming devices, mobile computing devices, mobile communication devices (e.g., smart phone), and/or other computing devices.

Computing system 600 includes a logic machine 602 and a storage machine 604. Computing system 600 may optionally include a display subsystem 606, input subsystem 608, communication subsystem 610, and/or other components not shown in FIG. 6.

Logic machine 602 includes one or more physical devices configured to execute instructions. For example, the logic machine may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The logic machine may include one or more processors configured to execute software instructions. Additionally or alternatively, the logic machine may include one or more hardware or firmware logic machines configured to execute hardware or firmware instructions. Processors of the logic machine may be single-core or multi-core, and the instructions executed thereon may be configured for sequential, parallel, and/or distributed processing. Individual components of the logic machine optionally may be distributed among two or more separate devices, which may be remotely located and/or configured for coordinated processing. Aspects of the logic machine may be virtualized and executed by remotely accessible, networked computing devices configured in a cloud-computing configuration.

Storage machine 604 includes one or more physical devices configured to hold instructions executable by the logic machine to implement the methods and processes described herein. When such methods and processes are implemented, the state of storage machine 604 may be transformed—e.g., to hold different data.

Storage machine 604 may include removable and/or built-in devices. Storage machine 604 may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage machine 604 may include volatile, nonvolatile, dynamic, static, read/write, read-only, random-access, sequential-access, location-addressable, file-addressable, and/or content-addressable devices.

It will be appreciated that storage machine 604 includes one or more physical devices. However, aspects of the instructions described herein alternatively may be propagated by a communication medium (e.g., an electromagnetic signal, an optical signal, etc.) that is not held by a physical device for a finite duration.

Aspects of logic machine 602 and storage machine 604 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 600 implemented to perform a particular function. In some cases, a module, program, or engine may be instantiated via logic machine 602 executing instructions held by storage machine 604. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

It will be appreciated that a “service”, as used herein, is an application program executable across multiple user sessions. A service may be available to one or more system components, programs, and/or other services. In some implementations, a service may run on one or more server-computing devices.

When included, display subsystem 606 may be used to present a visual representation of data held by storage machine 604. This visual representation may take the form of a graphical user interface (GUI), and display subsystem 606 may take the form of a computing display as described above. As the herein described methods and processes change the data held by the storage machine, and thus transform the state of the storage machine, the state of display subsystem 606 may likewise be transformed to visually represent changes in the underlying data. Display subsystem 606 may include one or more display devices utilizing virtually any type of technology. Such display devices may be combined with logic machine 602 and/or storage machine 604 in a shared enclosure, or such display devices may be peripheral display devices.

When included, input subsystem 608 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

When included, communication subsystem 610 may be configured to communicatively couple computing system 600 with one or more other computing devices. Communication subsystem 610 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 600 to send and/or receive messages to and/or from other devices via a network such as the Internet.

In an example, a method for moving an interface control comprises: displaying, via a graphical user interface of a computing display, an interface control having a first appearance at a first interface surface of the graphical user interface; receiving, via a computing device operatively connected to the computing display, a user input to move the interface control to a second interface surface of the graphical user interface; displaying, via the graphical user interface of the computing display, the interface control with a second appearance at the second interface surface of the graphical user interface; and based on displaying the interface control at the second interface surface of the graphical user interface, discontinuing display of the interface control at the first interface surface of the graphical user interface; where the interface control provides a first level of functionality when displayed at the first interface surface of the graphical user interface and a second level of functionality when displayed at the second interface surface of the graphical user interface. In this example or any other example, the first interface surface is selectively displayed on the graphical user interface. In this example or any other example, the second interface surface is persistently displayed on the graphical user interface. In this example or any other example, the first interface surface of the graphical user interface is a vertical sidebar surface. In this example or any other example, the second interface surface of the graphical user interface is a horizontal tray surface. In this example or any other example, the graphical user interface is rendered by an operating system of the computing device operatively connected to the computing display. In this example or any other example, each of the first interface surface of the graphical user interface and the second interface surface of the graphical user interface include a plurality of interface controls, and each of the plurality of interface controls are movable between the first and second interface surfaces of the graphical user interface based on user input. In this example or any other example, the interface control has a larger size and visually presents more information when displayed at the first interface surface of the graphical user interface than when displayed at the second interface surface of the graphical user interface. In this example or any other example, manipulation of the interface control causes a change in operation of one or more hardware components of the computing device operatively connected to the computing display. In this example or any other example, user-selection of the interface control while the interface control is displayed at the first interface surface of the graphical user interface causes display of a first interface window on the computing display, and user-selection of the interface control while the interface control is displayed at the second interface surface of the graphical user interface causes display of a second, different, interface window on the computing display. In this example or any other example, the first interface window is separate from the first interface surface of the graphical user interface, and the second interface window is contiguous with the second interface surface of the graphical user interface. In this example or any other example, the user input is a drag-and-drop operation.

In an example, a computing device comprises: a logic machine; and a storage machine holding instructions executable by the logic machine to: display a graphical user interface via a computing display, the graphical user interface including a first interface surface and a second interface surface, the first interface surface of the graphical user interface including an interface control having a first appearance; receive a user input to move the interface control to the second interface surface of the graphical user interface; display the interface control with a second appearance at the second interface surface of the graphical user interface; and upon displaying the interface control at the second interface surface of the graphical user interface, discontinue display of the interface control at the first interface surface of the graphical user interface; where the interface control provides a first level of functionality when displayed at the first interface surface of the graphical user interface and a second level of functionality when displayed at the second interface surface of the graphical user interface. In this example or any other example, each of the first interface surface of the graphical user interface and the second interface surface of the graphical user interface include a plurality of interface controls, and each of the plurality of interface controls are movable between the first and second interface surfaces of the graphical user interface based on user input. In this example or any other example, the interface control has a larger size and visually presents more information when displayed at the first interface surface of the graphical user interface than when displayed at the second interface surface of the graphical user interface. In this example or any other example, manipulation of the interface control causes a change in operation of one or more hardware components of the computing device. In this example or any other example, user-selection of the interface control while the interface control is displayed at the first interface surface of the graphical user interface causes presentation of a first interface window, and user-selection of the interface control while the interface control is displayed at the second interface surface of the graphical user interface causes presentation of a second, different interface window. In this example or any other example, the first interface window is separate from the first interface surface of the graphical user interface, and the second interface window is contiguous with the second interface surface of the graphical user interface. In this example or any other example, the first interface surface is selectively displayed on the graphical user interface, and the second interface surface is persistently displayed on the graphical user interface.

In an example, a method for moving an interface control comprises: displaying, via a graphical user interface of a computing display, an interface control having a first appearance and a first size at a first interface surface of the graphical user interface, the first interface surface being selectively displayed on the graphical user interface; receiving, via a computing device operatively connected to the computing display, a user input to move the interface control to a second interface surface of the graphical user interface, the second interface surface being persistently displayed on the graphical user interface; displaying the interface control with a second appearance and a second size at the second interface surface of the graphical user interface, the second size being smaller than the first size; and based on displaying the interface control at the second interface surface of the graphical user interface, discontinuing display of the interface control at the first interface surface of the graphical user interface; where user-selection of the interface control while the interface control is displayed at the first interface surface causes presentation of a first interface window separate from the first interface surface, and user-selection of the interface control while the interface control is displayed at the second interface surface causes presentation of a second, different interface window, the second interface window being contiguous with the second interface surface.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A method for moving an interface control, comprising:
displaying, via a graphical user interface of a computing display, an interface control having a first appearance at a first interface surface of the graphical user interface;
receiving, via a computing device operatively connected to the computing display, a user input to move the interface control to a second interface surface of the graphical user interface;
displaying, via the graphical user interface of the computing display, the interface control with a second appearance at the second interface surface of the graphical user interface; and
based on displaying the interface control at the second interface surface of the graphical user interface, discontinuing display of the interface control at the first interface surface of the graphical user interface;
where the interface control provides a first level of functionality when displayed at the first interface surface of the graphical user interface and a second level of functionality when displayed at the second interface surface of the graphical user interface.

2. The method of claim 1, where the first interface surface is selectively displayed on the graphical user interface.

3. The method of claim 1, where the second interface surface is persistently displayed on the graphical user interface.

4. The method of claim 1, where the first interface surface of the graphical user interface is a vertical sidebar surface.

5. The method of claim 1, where the second interface surface of the graphical user interface is a horizontal tray surface.

6. The method of claim 1, where the graphical user interface is rendered by an operating system of the computing device operatively connected to the computing display.

7. The method of claim 1, where each of the first interface surface of the graphical user interface and the second interface surface of the graphical user interface include a plurality of interface controls, and each of the plurality of interface controls are movable between the first and second interface surfaces of the graphical user interface based on user input.

8. The method of claim 1, where the interface control has a larger size and visually presents more information when displayed at the first interface surface of the graphical user interface than when displayed at the second interface surface of the graphical user interface.

9. The method of claim 1, where manipulation of the interface control causes a change in operation of one or more hardware components of the computing device operatively connected to the computing display.

10. The method of claim 1, where user-selection of the interface control while the interface control is displayed at the first interface surface of the graphical user interface causes display of a first interface window on the computing display, and user-selection of the interface control while the interface control is displayed at the second interface surface of the graphical user interface causes display of a second, different, interface window on the computing display.

11. The method of claim 10, where the first interface window is separate from the first interface surface of the graphical user interface, and the second interface window is contiguous with the second interface surface of the graphical user interface.

12. The method of claim 1, where the user input is a drag-and-drop operation.

13. A computing device, comprising:
a logic machine; and
a storage machine holding instructions executable by the logic machine to:
display a graphical user interface via a computing display, the graphical user interface including a first interface surface and a second interface surface, the first interface surface of the graphical user interface including an interface control having a first appearance;
receive a user input to move the interface control to the second interface surface of the graphical user interface;
display the interface control with a second appearance at the second interface surface of the graphical user interface; and
upon displaying the interface control at the second interface surface of the graphical user interface, discontinue display of the interface control at the first interface surface of the graphical user interface;
where the interface control provides a first level of functionality when displayed at the first interface surface of the graphical user interface and a second level of functionality when displayed at the second interface surface of the graphical user interface.

14. The computing device of claim 13, where each of the first interface surface of the graphical user interface and the second interface surface of the graphical user interface include a plurality of interface controls, and each of the plurality of interface controls are movable between the first and second interface surfaces of the graphical user interface based on user input.

15. The computing device of claim 13, where the interface control has a larger size and visually presents more information when displayed at the first interface surface of the graphical user interface than when displayed at the second interface surface of the graphical user interface.

16. The computing device of claim 13, where manipulation of the interface control causes a change in operation of one or more hardware components of the computing device.

17. The computing device of claim 13, where user-selection of the interface control while the interface control is displayed at the first interface surface of the graphical user interface causes presentation of a first interface window, and user-selection of the interface control while the interface control is displayed at the second interface surface of the graphical user interface causes presentation of a second, different interface window.

18. The computing device of claim 17, where the first interface window is separate from the first interface surface of the graphical user interface, and the second interface window is contiguous with the second interface surface of the graphical user interface.

19. The computing device of claim 13, where the first interface surface is selectively displayed on the graphical user interface, and the second interface surface is persistently displayed on the graphical user interface.

20. A method for moving an interface control, comprising:
displaying, via a graphical user interface of a computing display, an interface control having a first appearance and a first size at a first interface surface of the graphical user interface, the first interface surface being selectively displayed on the graphical user interface;
receiving, via a computing device operatively connected to the computing display, a user input to move the interface control to a second interface surface of the graphical user interface, the second interface surface being persistently displayed on the graphical user interface;
displaying the interface control with a second appearance and a second size at the second interface surface of the graphical user interface, the second size being smaller than the first size; and
based on displaying the interface control at the second interface surface of the graphical user interface, discontinuing display of the interface control at the first interface surface of the graphical user interface;
where user-selection of the interface control while the interface control is displayed at the first interface surface causes presentation of a first interface window separate from the first interface surface, and user-selection of the interface control while the interface control is displayed at the second interface surface causes presentation of a second, different interface window, the second interface window being contiguous with the second interface surface.
